(19) United States
(12) Patent Application Publication
(10) Pub. No.: US 2010/0176106 A1
(43) Pub. Date: Jul. 15, 2010

(54) Carriage for Automating Welding, Brazing, Cutting and Surface Treatment Processes

(76) Inventors: Kim Hardam Christensen, Dyssegard (DK); Ulf Larsen, Soborg (DK); Henrik Sorensen, Brondby (DK)

Correspondence Address: DAY PITNEY LLP, 7 TIMES SQUARE, NEW YORK, NY, 10036-7311, US

(21) Appl. No.: 12/223,237

(22) PCT Filed: Feb. 6, 2007
(86) PCT No.: PCT/DK2007/000063

§ 371 Date: Sep. 3, 2008

(30) Foreign Application Priority Data
Feb. 6, 2006 (EP) 06388006.6

(51) Int. Cl. B23K 9/00

(52) U.S. Cl. 219/137 R; 219/136

(57) ABSTRACT

This invention relates to a welding carriage operable to drive across a surface of a work piece having a joint to be welded. The welding carriage comprises a number of wheels, where each wheel is pivotal around an axle and where each wheel is a magnetic wheel; the welding carriage further comprises means for supporting a welding device wherein at least one of the wheels can be flexed inwardly or outwardly so that the welding carriage can travel over curved surfaces. The welding carriage can travel over magnetizable surfaces having any direction, e.g. orientation in space. The welding carriage can carry a laser sensor arrangement arranged to detect the position as well as the direction of a joint to be welded, so that the welding carriage is applicable for performing fully automated welding.

### FIELD OF THE INVENTION

The invention relates to a carriage for automating welding, brazing, cutting, surface treatment processes, etc. where the carriage comprises a number of wheels, where each wheel is pivotal around an axle and where each wheel is a magnetic wheel, wherein the welding carriage further comprises means for supporting e.g. a welding device. The invention moreover relates to methods for operating such a carriage.

### BACKGROUND OF THE INVENTION

Welding automation using a carriage for transporting a welding device, such as a welding torch, e.g. along a joint between two surfaces to be welded is well known in literature and accepted in the industry as a feasible tool for decreasing the involvement of a skilled human welder.

Several commercially available systems are known. For instance, Bug-O Systems, Gullco and ESAB produce rail-based systems where portable rails using permanent magnets are mounted to the welded structure for carrying and guiding a carriage holding the welding torch along the joint to be welded (vacuum cups are used for attaching the rails to non-ferrous structures). These rails must be mounted quite precisely, which requires a time consuming manual adjustment of the rails, in parallel to the joint in order to obtain a weld of sufficient quality. Furthermore, the rails are stiff and cannot follow small local deviations in the joint trajectory. A human weld operator therefore still has to watch the welding process and do online corrections of the equipment. Further, it is time consuming to lay out the rails arranged for supporting the welding carriage. Additionally, the position of the welding carriage is fixed once the rails have been placed.

Also a wide range of rail-less welding carriages are commercially available from several manufacturers like Bug-O Systems, SAF, ESAB, Fronius, and Migatronic. In general, these simple to use self-propelled carriages are designed for managing simple weld tasks where very primitive guidance mechanisms such as a track, grabbing arm etc. can be applied. Some of the carriages are purely for horizontal welding (e.g. downhand, PA according to ISO 6947), while other carriages are equipped with suspended electro or permanent magnets for use in all position welding. However, there are some obvious disadvantages of these carriages. For instance, the electricity can fail, for which reason the holding force of an electromagnet will vanish, while the holding force of a electromagnet as well as a permanent magnet varies and may drop critically when moving on very curved surfaces, e.g. inside a pipe if the diameter becomes too small.

Patent specification U.S. Pat. No. 5,853,655 discloses a remote controlled welding and cutting carriage equipped with magnetic wheels and one or more automated positioning arms holding e.g. welding torches. This/these motor driven arm(s) with photo sensors will track patterns delineated with a reflective tape etc. A disadvantage of this carriage is that it uses a reflective tape for guidance that very precisely has to be attached or affixed to the subject that is to be welded upon. Such subjects will normally be dirty and/or slightly corroded which further makes the attachment of the reflective tape difficult. Further, the attachment of the tape has to be done manually by a human operator. Additionally, the carriage is incapable of changing direction of movement since none of the wheels are turnable while the same single shaft drives a wheel in each side of the carriage.

Furthermore, European patent specification EP 0 759 337 discloses a rail-less carriage where a permanent magnet is incorporated inside the body of the carriage. A controller ensures that the traveling direction is kept without using any guide or rail. The use of a permanent magnet incorporated inside the body of the carriage does not provide as good a holding force between the magnet and the subject to be welded as required in some situations as there will be some distance between the subject to be welded and the magnet. This could especially be a problem when performing overhead welding inside a tube, pipe or container where there is a lower limit for the size of the respective tube, pipe or container. Further, no disclosure of active control for tracking the weld joint is given.

Patent specification JP 2001179448 discloses a rail-less welding carriage system applicable for automatic overhead welding, which can travel freely on a surface without the use of rails. A main carriage carrying welding equipment e.g. welding machine can freely travel on a shop floor surface, while controlling a smaller carriage connected to the main carriage with a boom. The smaller carriage (e.g. holding the welding torch) is turned around 180 degrees for performing overhead welding. The main carriage comprises a front set and a rear set of wheels. The front set of wheels can be turned in an angle compared to the travel direction thereby regulating the direction of the welding carriage. This welding carriage system is specially constructed for overhead welding.

Patent specification U.S. Pat. No. 6,627,004 also discloses a welding and cutting carriage equipped with magnetic wheels and a positioning arm holding e.g. a welding torch. However, both the carriage and the motor driven arm are purely remote controlled by a human welding operator.

Finally, a new type of welding carriage is described in the article: “Crawl-type Robot Tackles Difficult Jobs”, Welding Journal, Vol. 84, No. 1, 2005, pp. 50-54, Pan, J., Yan, B., Gao, L., Zhang, H., Lu, Q., and Jin, K. This automated carriage uses magnetic tracks consisting of a series of permanent magnet blocks, which are connected by chains, for which reason the carriage crawl on a structure like a military tank moves on the ground. For tracking the joint to be welded, a traditional laser sensor is used that measures the welding joint profile along a line regardless of the orientation of the line with respect to the orientation of the joint.

### SUMMARY OF THE INVENTION

It is an object of the invention to provide a welding carriage comprising surface adaptive means. This object is achieved, when the welding carriage mentioned in the opening paragraph is characterized in that at least one of the wheels of the welding carriage are arranged to be flexed to assume more than one angle compared to a bottom side and/or top side of the welding carriage. For example, all four wheels of a welding carriage comprising four wheels may be arranged to be flexed to assume more than one angle compared to a bottom side and/or top side of the welding carriage. Hereby, at least one of the wheels of the welding carriage may be able to adapt to any surface e.g. a planar surface and/or a spherical surface and/or a cylindrical surface etc. Further, the left set of wheels and/or the right set of wheel and/or each individual wheel can be bent e.g. inwards, i.e. towards the bottom side of the carriage, so that the wheels of the welding carriage will have an appropriate contact with a curved surface of a work piece to be welded. If the wheels are bent outwards, the carriage can be used on the inside of cylinders, pipes, etc. Preferably, said more than one angle comprises angles between −45° and 45°, and more preferably between −30° and 30°. Further, by having magnetic wheels, the welding carriage can be used to travel across any surface capable of being magnetized or attracted by a magnet, i.e. also non-horizontal surfaces. Thus, the welding carriage is capable of facilitating welding on flat or curved surfaces regardless of the orientation and slope thereof. For other types of operations the carriage may carry other devices e.g. such as a cutting tool. Further, the need for an affixing of separate track rail or alternative mechanical guidance devices may be eliminated.

In another preferred embodiment, the welding carriage further comprises a sensor arrangement arranged to detect the position and the direction of a joint to be welded. This detection of the position as well as the direction of the joint can be used in order to control the direction and the speed of movement of the welding carriage to facilitate automated welding without the use of a track or rails or other guidance mechanisms, which have to be fit up and adjusted by a human operator.

In one embodiment of the welding carriage, the sensor arrangement is a laser sensor arrangement arranged to emit at least two laser beams and to detect reflections of said at least two laser beams from a work piece.

Preferably, the at least two laser beams, e.g. projected onto the workpiece as lines perpendicular to the joint (when the carriage is moving along the joint), are arranged so that the distance between the lines on the workpiece are in the range of about a few to some tens of millimetres, e.g. between 5 mm and 30 mm, depending on the joint to be welded. More than two laser beams could be used, e.g. the use of three laser beams would render more stable and/or accurate detections of the position and direction of a joint to be welded. It should be noted that the term “laser sensor arrangement” is meant to cover any laser module with means for generating a laser beam as well as detectors, such as CCD cameras, to detect reflections of the laser beam.

In an alternative, preferred embodiment of the welding carriage according to the invention, the welding carriage further comprises means for tactilely detecting the position of a rail placed along a joint to be welded. This rail can be placed on the work piece to be welded in a certain distance from the joint to be welded so that the welding carriage can sense the position of the rail and thereby determine the position of the joint to be welded. The rail can be any rail the presence of which can be detected tactilely by welding carriage; however, if the work piece to be welded is magnetizable, a magnetic rail is useful in that in can be placed and removed easily. Typically, the means for tactilely detecting the position of a rail is arranged for detecting the position of a relatively small rail, e.g. a rail having a rectangular cross section with dimensions of some millimetres to some centimetres. The use of tactilely detecting of the position may e.g. be useful when the carriage is used for cutting as there will not be a welding joint to navigate after.

In yet a preferred embodiment of the welding carriage according to the invention further comprises a welding device and processor means are arranged for controlling welding parameters of said welding device on basis of joint geometry measurements using the laser sensor arrangement. Such welding parameters are e.g. the current or voltage applied to the welding device, the welding speed, the wire feed speed, etc. Hereby, a fully automated welding carriage arranged to determine the position and direction of a joint to be welded and to perform an appropriate welding of the joint whilst moving along the joint without the use of rails or other guidance mechanisms, which have to be fit up/adjusted by a human operator is achieved. The joints, which can be welded, comprise but are not limited to: V-groove joints, butt joints, lap joints and fillet welds. Preferably, the controlling of welding parameters is based on a mathematical model, said mathematical model being either empirical, based on general laws of physics or a combination thereof. Such a combination could be the use of a model based on general laws of physics calibrated by means of empirical results. Advantageously, the mathematical model could also be based on neural networks.

It should be noted that the above control of welding parameters are particularly advantageous in welding the root pass (also denoted root run) between two work pieces to be welded in joint welding. Traditionally, the welding of such a root pass has involved a piece of heat resisting material, e.g. ceramics, placed underneath the joint, which piece has been arranged to carry the melted welding material having passed through the joint to be welded. With the above control of welding parameters the presence of such a piece of ceramics can be avoided, in that the welding process can be controlled so that substantially no melted welding material passes through the joint. Hereby, the placing and holding of the piece of ceramics can be avoided, and work pieces, such as small containers, where the placing of such a piece of ceramics is impossible, can be welded by the inventive welding carriage.

The invention moreover relates to a method of operating a welding carriage having features and advantages corresponding to the welding carriage.

### BRIEF DESCRIPTION OF THE DRAWINGS

The invention will be explained more fully below in connection with examples of preferred embodiments and with reference to the drawing, in which:

FIG. 1 is a schematic drawing of a welding carriage according to the invention;

FIG. 2a is a cross section along the line II-II in FIG. 1;

FIG. 2b is a cross section corresponding to the cross section in FIG. 2a, but with the axles of the wheels flexed the angle v;

FIG. 3 is a schematic drawing of an embodiment of a laser sensor arrangement used in the welding carriage according to the invention;

FIG. 4 is a block diagram of the components of the welding carriage and processor and control means;

FIG. 5 is a schematic drawing corresponding to FIG. 1, but including a welding device and a sensor arrangement;

FIG. 6 is a flow diagram of a method of operating a welding carriage according to the invention;

FIG. 7 is a schematic diagram of a welding carriage according to one embodiment of the present invention seen from above; and

FIG. 8 is a schematic drawing illustrating an example of how the wheels may be arranged to move.

FIG. 9 is a schematic drawing of a welding carriage comprising a chassis and four wheels.

FIG. 10 is a schematic drawing of a welding carriage with wheels on line or offset.

FIG. 11 is a schematic drawing of a set of wheels of a welding carriage.

FIG. 12 is a schematic drawing of a welding carriage axle suspension.

FIG. 13 a) is a schematic drawing of a tank control embodiment of a welding carriage.

FIG. 13 b) is a schematic drawing of an articulated welding carriage control.

FIG. 13 c) is a schematic drawing of an articulated welding carriage control with a centre chassis.

FIG. 13 d) is a schematic drawing of an articulated welding carriage control with centre chassis and independent axles.

FIG. 13 e) is a schematic drawing of an articulated welding carriage control with individual motorized wheel turning.

Throughout the figures identical reference numerals denote identical components.

### DESCRIPTION OF PREFERRED EMBODIMENTS

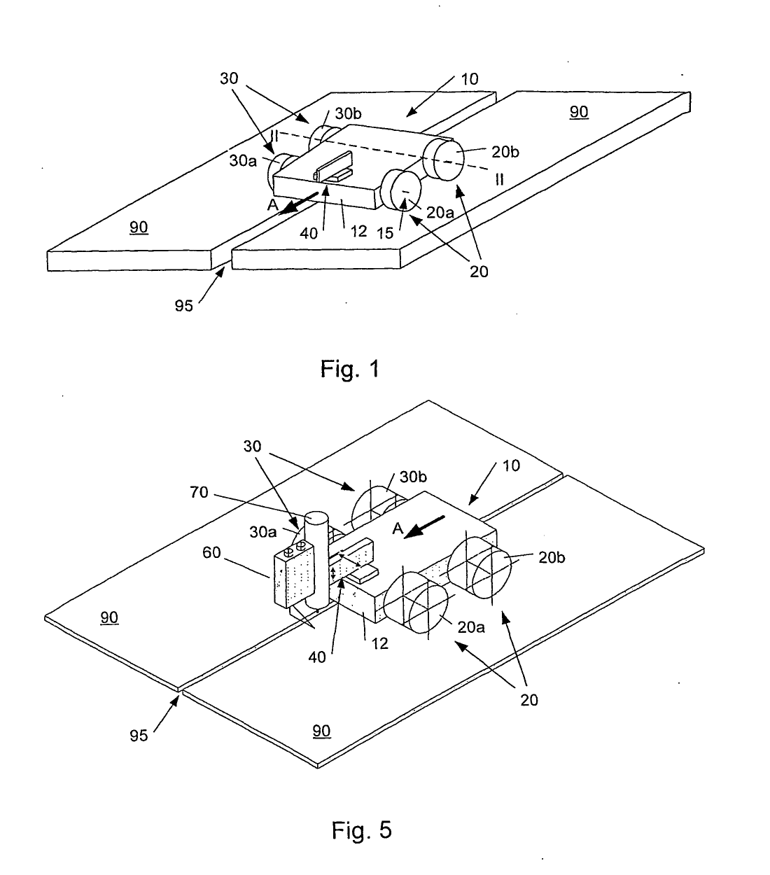

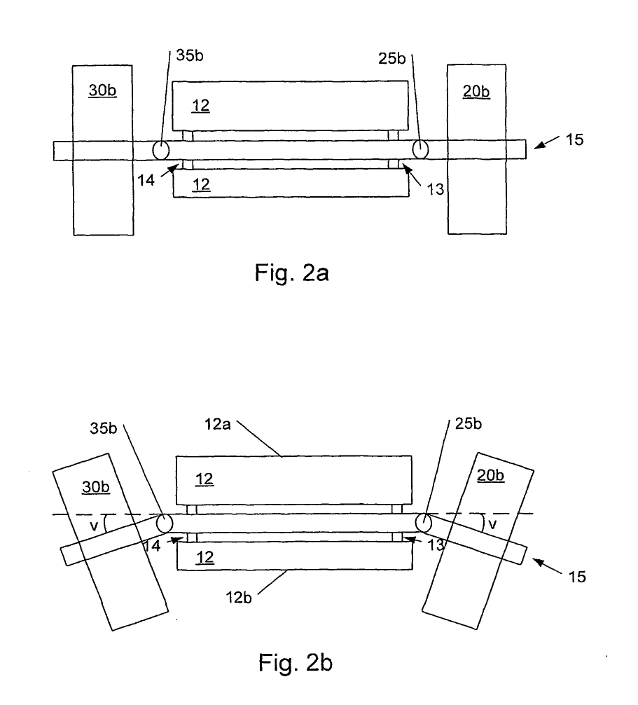

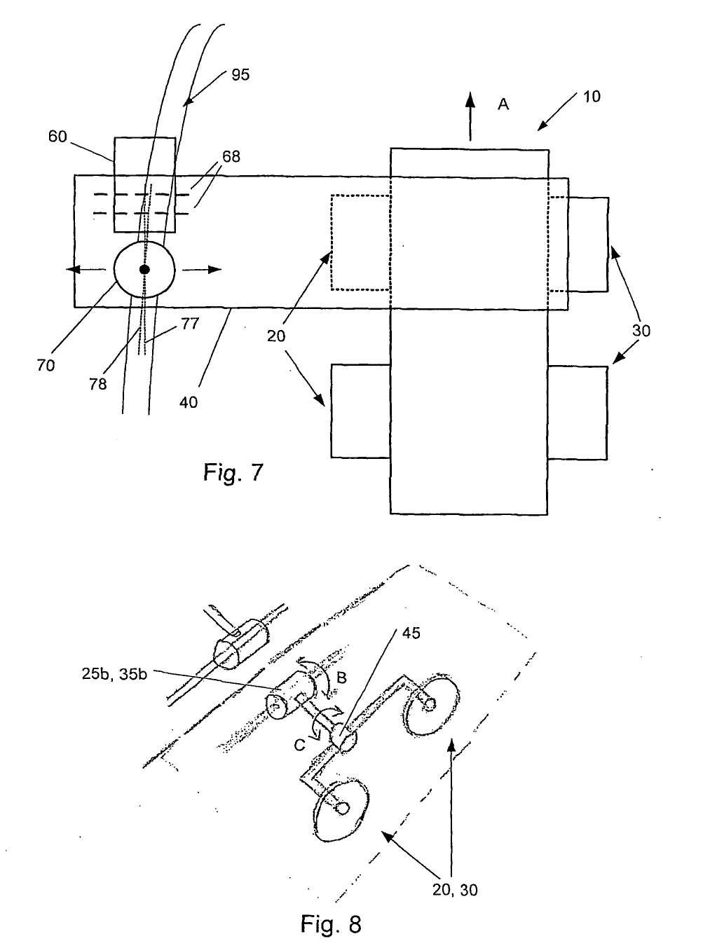

FIG. 1 is a schematic drawing of a welding carriage 10 according to an embodiment of the invention. The welding carriage 10 is placed upon a work piece 90 having a joint 95 which is to be welded. The welding carriage 10 has a direction of movement indicated by the arrow A. The welding carriage 10 has a body/chassis 12 and two sets of wheels 20, 30, whereof one set of wheels 20 is a left set of wheels 20a, 20b and the other set of wheels is a right set of wheels 30a, 30b, where the indications “left” and “right” correspond to the wheels on the left and right side, respectively, of the welding carriage when this is seen from above in such an orientation that the direction of movement is forward. Each wheel is pivotal around an axle 15 extending through the body 12 of the welding carriage 10 (also see FIGS. 2a and 2b). Also shown in FIG. 1 is adjustable means 40 for supporting a welding device, such as a welding torch and/or a cutting device and/or another device. When the welding carriage is applied to welding operations, the means 40 naturally carry an appropriate welding device (not shown in FIG. 1; see e.g. FIGS. 5 and 7).

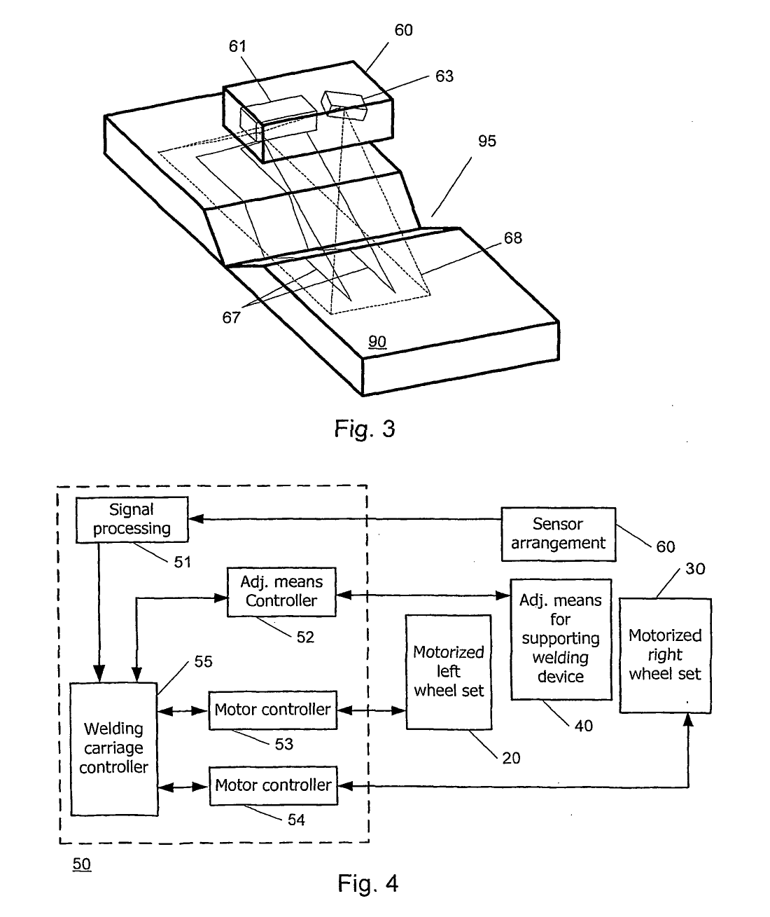

According to a preferred embodiment of the present invention, the welding carriage 10 is sensor guided, as explained in greater detail in connection with FIGS. 3-7).

In an additional embodiment, said welding carriage is manually controlled as further disclosed below.

In an additional embodiment, said welding carriage is controlled via a combination of sensor guiding and manual guiding.

The wheels 20, 30 of the carriage 10 are preferably magnetic wheels thereby enabling the carriage 10 to propel across any surface capable of being magnetized or attracted by a magnet. Furthermore, the mechanical design of the carriage 10 (as explained in greater detail in connection with FIGS. 2a and 2b) enables the wheels to be moved very flexibly thereby ensuring a strong magnetic attraction of the wheels to the material to be welded even on highly curved surfaces. Hence, the carriage is capable of facilitating welding on flat or curved surfaces regardless of orientation and slope, e.g. around the circumference of a pipe or in general applicable for all-position welding.

According to the present invention, the left and the right wheel set 20, 30 of the carriage are driven by each their own motor (not shown; see e.g. FIG. 4), e.g. a DC servomotor or the like. Each motor drives the left and the right wheel set of the carriage individually. Consequently, obtaining a difference in the speed the two wheel sets changes the direction of movement of the carriage.

Furthermore, for ensuring an exact positioning horizontally, as well as vertically of the welding device proportional to the joint to be welded 95, the adjustable means 40 for supporting a welding device is used. In one embodiment, these means 40 are a cross slide holding the welding device that is mounted on the welding carriage as explained later. The position and orientation of the adjustable means 40 with respect to the carriage typically depends on the particular welding task, e.g. different tasks such as welding of a V-groove, fillet welding, etc. which may require different orientation.

The wheels, when magnetic, will tend to attract dirt such as metal chips etc. appearing in a typical welding environment. In order to reduce and/or eliminate any negative effect on the control quality of the welding carriage of this particular disturbance (magnetically attractable dirt), the wheels are preferably kept clean by mounting a device, which will scrape off such dirt from the wheels.

In order to avoid spatter of molten metal, which may appear in e.g. MIG/MAG welding, i.e. gas shielded metal arc welding, to be attracted by the magnetic wheels, the carriage can be equipped with spatterguards to protect the wheels.

In one embodiment, the welding carriage may have e.g. 3 wheels. Alternatively, the welding carriage may have e.g. 4 wheels. Alternatively, the welding carriage may have any number of wheels suitable for moving the welding carriage across a surface.

In an additional embodiment, the welding carriage may comprise an antenna for receiving control data e.g. from a handheld device or a control panel as disclosed below. Said welding carriage may further transmit data, e.g. positional data and/or data related to the joint 95, via said antenna to e.g. a control panel. Said antenna may be in connection with processing means 50 of said welding carriage.

FIG. 2a is a cross section along the line II-II in FIG. 1, i.e. through the axle 15 of the wheels 20b and 30b. The axle 15 extends through the body 12 of the welding carriage and is supported therein by means of two bearings, axle boxes or the like 13, 14. The axle 15 is also shown to comprise two joints 25b, 35b arranged to flex the part of the axle 15 bearing the wheels 20b, 30b into different angles. In FIG. 2a the axle 15 is shown in a non-flexed state corresponding to a fully straight axle 15.

FIG. 2b is a cross section corresponding to the cross section in FIG. 2a, but with the axles of the wheels 20b, 30b flexed the angle v. This angle v will typically lie in the range between −45° and 45°, and more preferably between −30° and 30°. In this description, positively angles denote downwards flexing of the wheels as shown in FIG. 2b, whilst negative angles denote upwards flexing of the wheels and the angle 0° corresponds to FIG. 2a. It should be noted, that the left set of wheels 20 and the right set of wheels 30 not necessarily is flexed by the same angle v, in that it is conceivable that the flexing of one set of wheels differs from the flexing of the other. However, typically the wheels in the each set of wheels will be flexed by the same angle. Alternatively, each of the wheels may flex at an angle independent of the other wheels.

In this way, the left wheel set and/or the right wheel set and/or each individual wheel can be bent e.g. inwards, i.e. towards the bottom side of the carriage, so that the wheels of the welding carriage will have an appropriate contact with a curved surface of a work piece to be welded. If the wheels are bent outwards, the carriage can be used on the inside of cylinders, pipes, etc. Preferably, the angle v is selected from angles between −45° and 45°, and more preferably between −30° and 30°.

It should be noted, that even though FIGS. 2a and 2b show the use of two joints 25b, 35b on an axle 15, it is also conceivable to use only one joint on each axle 15. This is especially advantageous if the welding carriage is relatively slim, i.e. that the distance from the right wheels 30a and 30b, respectively, to the left wheels 20a and 20b, respectively, is relatively small.

An alternative arrangement of how the wheels may be arranged to move is shown and explained in connection with FIG. 8.

FIG. 3 is a schematic drawing of an example of a laser sensor arrangement 60 used in the welding carriage according to one embodiment of the present invention. The laser sensor arrangement 60 comprises a laser module 61 comprising, in this embodiment, two laser diodes or other laser sources having line generators. Each laser diode is arranged to emit a laser beam 67 which is to be projected onto a surface of a work piece 90. This is indicated in FIG. 3 by the lines extending below the laser module 61.

The laser arrangement 60 moreover comprises picture or video capturing means like a CCD camera 63 positioned at a triangulation angle to the two laser module 61. The CCD camera 63 are arranged to receive the reflection of the laser beams from the laser module 61 from the surface of the work piece 90. The field of view of the CCD camera 63 is indicated in FIG. 3 by the broken lines 68 extending below the CCD camera 63. Preferably, the two laser diodes is alternating switched on and off so only one of them is on at a single time (or with a limited overlap). In this way, it is very easy to determine from which of the diodes the reflections arises from that the CCD camera is currently is registering. In this way, only a single CCD camera is needed.

A band pass filter (not shown) may be placed in front of the CCD camera in order to filter out noise, remove light with uninteresting wavelengths, and/or the like.

As an alternative the laser module 61 could comprise a single laser diode or the like having optical or other means for generating two separate laser lines along the surface of a work piece. Moreover, more than two scan lines or other geometries than scan lines are conceivable; e.g. three scan lines would render the measurements more reliable or stable. As another alternative, the video or picture capturing means 63 could be substituted by a two or more video or picture capturing means or by a single capturing means where the registered picture is divided into two parts (one for each laser line), which would avoid the need for alternating switching on and off the laser diodes.

Please note, that an optimal distance between the laser scan lines in parallel typically will depend on the specific joint preparation, e.g. joint type, preparation accuracy, quality etc.

In one embodiment, the laser modules further comprises adjustment means for adjusting the distance between the laser scan lines. In a further embodiment, the distance is adjusted automatically, e.g. depending on a given pre-set, on actual automatically measured parameters or a combination thereof.

Due to the capability of this sensor 60 to locate the position and orientation of the joint to be welded, the sensor is very applicable for guiding the carriage and welding device as already described. It has been shown that joints like the V-groove, butt joint, lap joint and fillet weld can be welded in this manner in an automated way.

FIG. 4 is a block diagram of the components of the welding carriage and processing and control means 50. Shown is the welding carriage that comprises a motorized left wheel set 20 and a motorized right wheel set 30, a sensor arrangement 60 and adjustable means 40 for supporting a welding device. The adjustable means for supporting a welding device 40 may e.g. be a so-called motorized cross slide or the like holding the welding device in a well known and controllable way. Assuming that the dynamic performance of this cross slide is good, it may also be used for torch oscillation, if needed. Alternatively, other adjustable means for supporting a welding device 40 may be used (se e.g. FIG. 7 for an example of another layout of the adjustable means 40). The position and orientation of the adjustable means for supporting a welding device with respect to the carriage will typically depend on the particular weld task. The welding carriage moreover comprises processing means 50 for controlling the operation of the welding carriage.

In an additional embodiment, the processing means for controlling the operation of the welding carriage may be comprised in a device suitable for being handheld thereby enabling a user of the welding carriage to manually control the welding carriage by controlling said handheld device. Said handheld device may, for example, be a remote control device comprising an antenna and controls for manual control of said welding carriage. Further, the handheld device may comprise one or more processor means such as e.g. one or more CPUs. Said handheld device may be wirelessly connected to said welding carriage e.g. connected via Bluetooth, via IR communication and/or via WLAN, etc for transmitting data between said handheld device and said welding carriage e.g. control data from said handheld device and to said welding carriage and/or sensor data from said welding carriage to said handheld device. Alternatively or additionally, said handheld device may comprise a physical connection to said welding carriage for controlling said welding carriage e.g. an optical cable and/or an electrical cable for transmitting data between said handheld device and said welding carriage.

In an additional embodiment, said processing means for controlling the operation of the welding carriage may be comprised in a computer physically separated from said welding carriage. Said computer may, for example, be placed in a control panel. Said computer may comprise and/or be in connection with an antenna. Said computer may be wirelessly connected to said welding carriage via said antenna for transmitting (e.g. control data) and/or receiving data (e.g. sensor data) via Bluetooth, via IR communication and/or via WLAN, etc., to/from said welding carriage. Alternatively or additionally, said computer may comprise a physical connection to said welding carriage for controlling said welding carriage and/or receiving sensor data from said welding carriage e.g. via an optical cable and/or an electrical cable for transmitting data between said computer and said welding carriage.

In an additional embodiment, an operator may manually control the welding carriage via a handheld device and/or via a control panel as disclosed above. Sensor data may be transmitted from the welding carriage to the handheld device and/or control panel. Processing means in said handheld device and/or control panel may process said sensor data and based on said processing of said sensor data one or more parameters of the welding carriage e.g. welding current may be controlled. Thereby, the welding carriage may be controlled via a combination of sensor guiding and manual control.

In an additional embodiment, said processing means for controlling the operation of the welding carriage may comprise a plurality of processing means at a plurality of locations. For example, the welding carriage may comprise, at each wheel, a motor controlling the respective wheel. Further, the welding carriage may comprise one or more processing means, such as for example one or more CPUs, controlling each of said motors controlling said wheels. Additionally, a user may transmit control data to said welding carriage e.g. via a handheld device, as disclosed above, said handheld device comprising one or more CPUs.

In an additional embodiment, the processing means comprises a signal processing component 51 arranged to receive input from the sensor arrangement 60. The received input is processed in order to derive a joint position, a joint orientation and information about joint geometry, e.g. gap, groove angels, etc., if needed. After processing of the input information the signal processing block 51 outputs a signal with the obtained joint position, joint orientation, etc. to a welding carriage controller 55. The adjustable means controller 52 moreover receives an input signal from the adjustable means 40 with information on the position thereof. The adjustable means controller 52 outputs a signal to the welding carriage controller 55 with information on said position of the adjustable means for supporting welding device as well as a signal to the adjustable means 40 for controlling any adjustment of the position thereof. The welding carriage controller 55 further receives position and velocity from the two motor controllers 53 and 54. Based on the positions of the motorized wheel sets 20, 30 and the adjustable means 40 and the location and orientation of the joint the welding carriage controller 55 derives new reference positions/velocities that is provided to the adjustable means controller 52 and the motor controllers 53 and 54 whereof one motor controller 53 drives the left wheel set 20 of the welding carriage and the other motor controller 54 drives the right wheel set 30.

In an additional embodiment, said processing means may comprise communication means such as e.g. an antenna for communicating wirelessly with said welding carriage. Alternatively or additionally, said processing means may comprise communication means such as e.g. an optical cable and/or an electrical cable for transmitting data between said communication means and said welding carriage.

In an additional embodiment, said welding carriage is battery powered. Alternatively or additionally, said welding carriage is electrically powered e.g. from a control panel connected to said welding carriage via an electrical power cable. Alternatively, said welding carriage is powered by a combustion engine such as e.g. a gasoline or diesel engine.

Preferably, the processor and control means is a model based control system that controls the drives of the carriage in order to make the carriage accurately track the joint to be welded with regard to position as well as velocity (welding speed). In a preferred embodiment, a mathematical model modeling the carriage, the means for supporting a welding device 40, the sensor arrangement 60 and a welding device is used for controlling the drives of the carriage fulfilling the constrains of a given weld task, i.e. the position of the welding torch relative to joint, the welding speed, and e.g. a weaving amplitude, if applicable.

Typically, a total of four drives have to be controlled; the two motors 53, 54 driving the wheel sets independently and, typically, two drives for controlling the motion of the adjustable means for supporting a welding device 40. Assuming that these means 40 is a cross slide characterized by a good dynamic performance, the precise positioning horizontally as well as vertically of the welding torch proportional to the joint to be welded is managed by these adjustable means. Meanwhile the welding carriage just has to be controlled to follow the joint to a certain degree constrained by movement limitations of the adjustable means for supporting a welding device 40, e.g. by stroke lengths of the linear motion slides and the dynamic performance thereof for a cross slide. Obviously, apart from the vertical motion slide the three other drives of the system are coupled.

In an additional embodiment, any number of drives may have to be controlled. For example, one motor for each wheel and two drives for controlling the motion of the adjustable means for supporting a welding device 40.

FIG. 5 is a schematic drawing corresponding to FIG. 1, but including a welding device and a sensor arrangement. Shown is a welding carriage 10 corresponding to the one shown in FIG. 1 but where a sensor arrangement 60, preferably a laser sensor arrangement 60, and a welding device 70 is mounted on the carriage 10. In this particular example, the welding device 70 is mounted on the adjustable means 40 for supporting a welding device and the sensor arrangement 60 is located on the welding device 70 so that its scan lines are in front of the carriage 10.

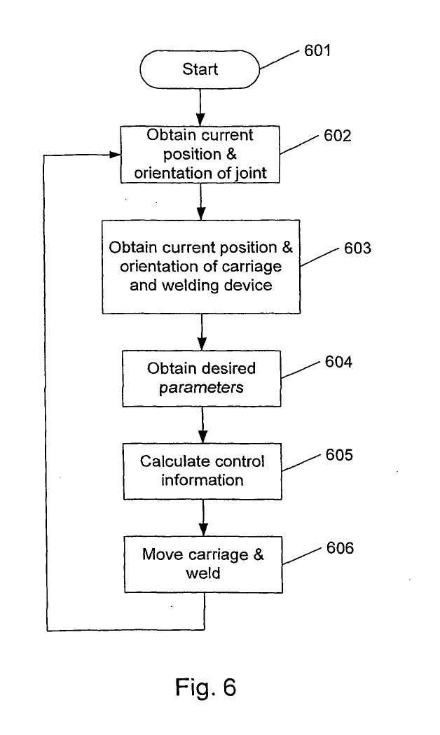

FIG. 6 is a flow diagram of a method of operating a welding carriage according to the invention. The method could be implemented as indicated by FIG. 4. The method starts or initiates at step 601. At step 602 the current (e.g. relative) position and orientation of the joint to be welded is obtained or estimated, preferably using a sensor arrangement as described previously. Preferably, a joint centerline is determined or estimated using image processing.

At step 603, the current (e.g. relative) position and orientation of the carriage and of the welding device is obtained. The position and orientation of the carriage is preferably determined by obtaining position and velocity of each wheel set independently. The position and orientation of the welding device is preferably determined by obtaining a measured position of linear motion slides for the adjustable means (40 in FIGS. 1, 4, 5 and 7) for supporting a welding device.

At step 604, a number of desired parameters are provided. The parameters may e.g. include a desired welding speed (i.e. speed of the carriage), a desired position of the welding device, preferably perpendicular to the joint centerline, including weaving amplitude, if applicable,

The desired parameters typically vary with the actual weld task to be performed. A simple well-defined weld task such as fillet weld with very few passes, etc. can be fully automated using constant welding parameters (e.g. wire feed speed, voltage, welding speed, torch oscillation). However, more complex tasks, such as welding of open V-grooves, multi-pass welding, etc. may require a continuous adjustment of significant welding parameters such as welding voltage, current, welding speed, weaving amplitude, stick-out etc. Therefore, according to a further embodiment, of the present invention, the laser sensor arrangement will not only perform seam tracking but will also measuring characteristic features of the joint to be welded, like the gap or groove angles of an open V-groove, or the like. Based on this information significant welding parameters are adjusted to ensure successful welding even if the joint geometry varies. For this, a mathematical model, e.g. purely based on experiments (empirical model based on classic regression, neural networks etc.), based on general laws of physics or a combination where a model based on general laws of physics is calibrated to multiple experiments is needed.

At step 605, the control information for the carriage and welding device are calculated using the information obtained at steps 602-604. Preferably, the derived control information comprises a reference velocity for each of the left and right wheel set, respectively and a reference position and velocity of linear motion for the welding device (via the adjustable means for supporting the welding device).

Please note that typically, the measurements of the joint location as well as geometry at step 602 are acquired at a distance to the welding device. The distance may e.g. be 20 mm to 50 mm. Therefore these measurements are stored in a controller or the like until the welding device reaches the positions of measurements.

At step 606, the derived control information is used and supplied to the relevant parts of the carriage (see e.g. FIG. 4 and related description) and the carriage and welding device are moved accordingly during which a part of the joint is welding.

After step 606 has been done the method repeats steps 602-606 while the carriage performs welding operation(s). Preferably, the operation of the carriage and the execution of the steps takes place in real-time, near real-time, or substantially real-time during operation. Alternatively, the operation is performed segments, if needed.

Please note that some of the steps, e.g. steps 602, 603, and 604, may be performed in parallel or substantially in parallel or in a different ordering.

FIG. 7 is a schematic diagram of a welding carriage according to one embodiment of the present invention seen from above. Shown is a welding carriage 10 according one embodiment of the present invention, where the welding carriage 10 is placed upon a work piece having a joint 95 to be welded. The welding carriage 10 has a direction of movement indicated by the arrow A. The welding carriage 10 comprises two sets of wheels 20, 30, controlled independently as explained previously.

Also shown is adjustable means 40 for supporting a welding device, such as a welding torch and a sensor arrangement 60, a laser sensor arrangement in this example, and a welding device 70 being mounted on the adjustable means 40 for supporting a welding device, cutting device, etc. The laser sensor arrangement emits two scan lines that are detected 68 and used as explained previously. Also indicated is a first (77) and a second (78) broken line representing the direction of the carriage and the centerline of the joint, respectively. Based on the information received from the sensor arrangement and information of the location and velocity of the welding device 70 and the two sets of wheels 20, 30 the joint to be welded is followed and welded allowing for precise and automated welding of the joint, even for complex welding tasks.

FIG. 8 is a schematic drawing illustrating an example of how the wheels may be arranged to move. Shown is a set of wheels (20, 30) on one side of the carriage. A corresponding set of wheels is present at the other side of the carriage. In this particular embodiment a set of wheels may be moved by controlling the movement of a joint 25b, 35b arranged to flex the set of wheels into different angles as indicated by the double-arrow B. The joints are preferably not constrained and will thus automatically adjust to the surface that the carriage is located on.

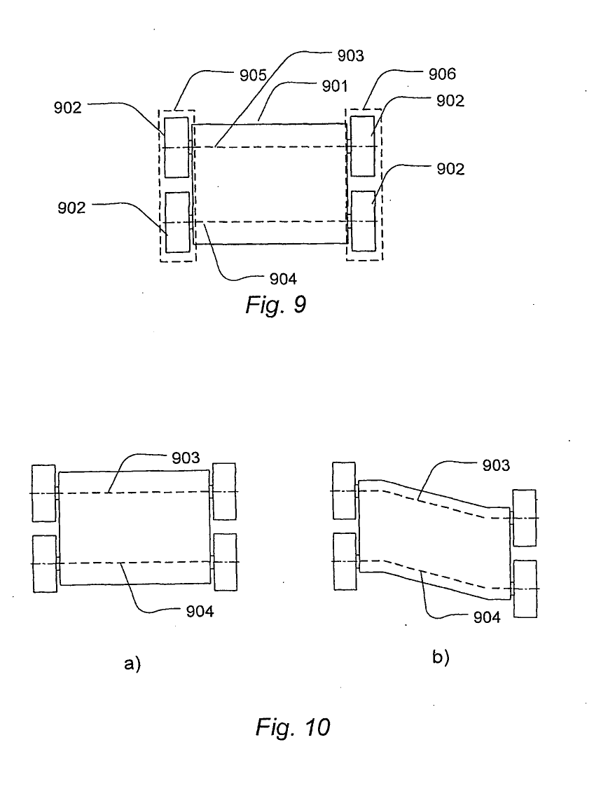

FIG. 9 shows an embodiment of a welding carriage comprising a chassis 901 and four wheels 902, where each of the four wheels may be motorized. The welding carriage may comprise a front axle 903 and a rear axle 904. Further, the welding carriage may comprise a left set of wheels 905 and a right set of wheels 906.

FIG. 10 shows an additional embodiment in which the wheels of an axle of the welding carriage, e.g. the front axle 903 and/or the rear axle 904, may be mounted on line as seen in the left figure, FIG. 10 a), or with an offset as seen in the right figure, FIG. 10 b). If the wheels of a welding carriage are offset as illustrated in FIG. 10 b), the welding carriage may have an increased ability to move over a rugged surface e.g. a surface with one or more welding seems etc.

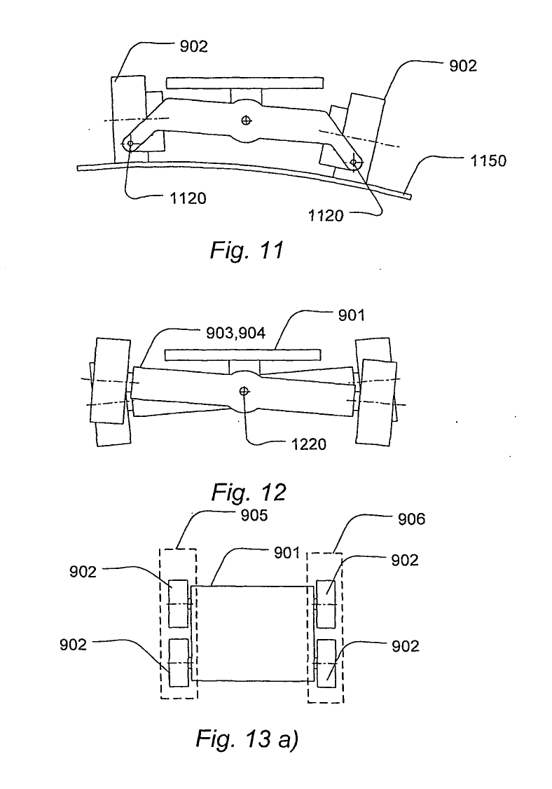

FIG. 11 shows an additional embodiment in which, in order to obtain optimal contact between a surface 1150 and the magnetic wheels 902, each wheel 902 is suspended in a joint 1120 that allows the wheel 902 to adapt to the curvature of the surface 1150. Further, the figure illustrates that a wheel suspended in a joint may secure a line or near-line contact between the wheel and said surface.

FIG. 12 shows an additional embodiment, in which one or more of the welding carriage's axles, e.g. the front axle and/or the rear axle 903, 904, are suspended in a joint 1220 allowing the one or more axles 903, 904 to move relative to the chassis 901 of the welding carriage. This enables the wheels of the welding carriage to have contact with a surface also in the case of double curved surfaces.

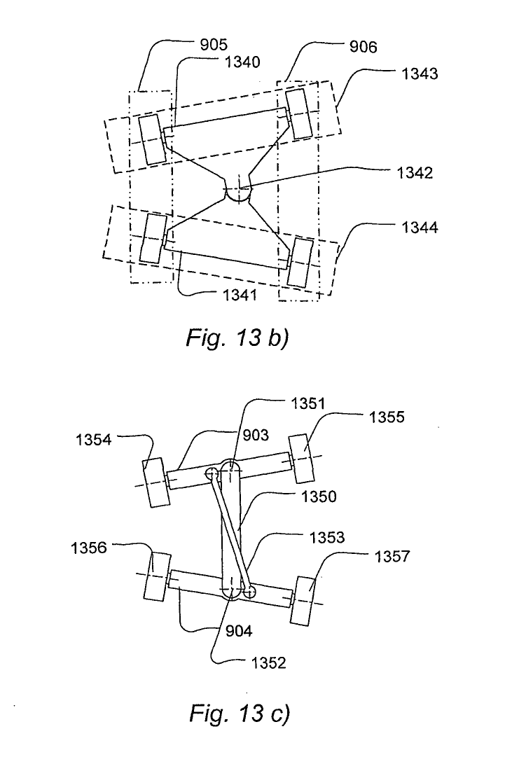

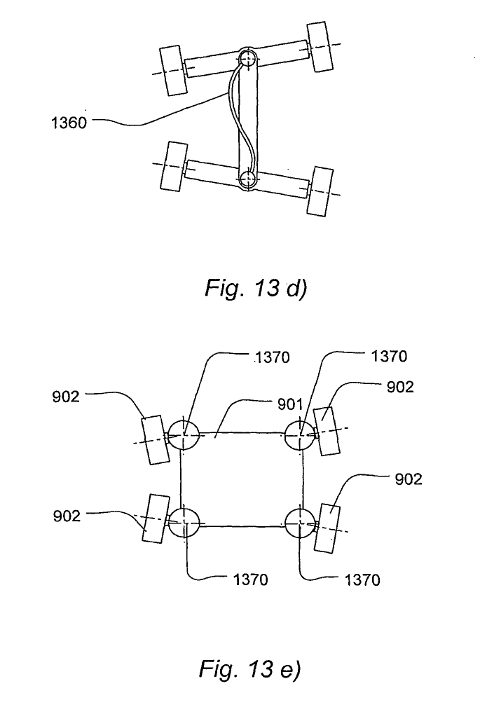

FIG. 13 shows different types of chassis configurations together with possible wheel transmission and appropriate motor controller whereby the welding carriage is enabled to move along a desired path.

FIG. 13 a) shows a tank control embodiment in which the wheels 902 are mounted on a common chassis 901 of the welding carriage. The welding carriage may, in this embodiment, turn by applying a first speed to a first set of two wheels, e.g. the left set of wheels 905, and a second speed to a second set of two wheels, e.g. the right set of wheels 906. The first and second speeds may be different in order to turn the welding carriage.

FIG. 13 b) shows an articulated welding carriage control in which the chassis comprises a first part, e.g. a front part 1340, and a second part, e.g. a rear part 1341, and said first and said second parts 1340, 1341 are connected via a center joint 1342. In this embodiment, a first set of two wheels 1343 may be mounted on the first part of the chassis and a second set of two wheels 1344 may be mounted on the second part of the chassis. The welding carriage may, in this embodiment, turn by applying a first speed to a first set of two wheels, e.g. the left set of wheels 905, and a second speed to a second set of two wheels, e.g. the right set of wheels 906. The first and second speeds may be different in order to turn the welding carriage.

FIG. 13 c) shows an articulated welding carriage control with a centre chassis in which the chassis comprises a main centre part 1350 on which the front axle 903 is connected through a joint 1351 in a first end of the centre part and the rear axle 904 is connected through a joint 1352 in a second end of the centre part. The front axle 903 and the rear axle 904 are additionally connected via a rod 1353 for symmetrical turning of said front and rear axles 903, 904 relative to the main centre part 1350. A first set of two wheels 1354, 1355 are mounted on the front axle 903, one wheel right 1355 and one wheel left 1354 and a second set of two wheels 1356, 1357 are mounted on the rear axle 904, one wheel right 1357 and one wheel left 1356. The welding carriage may, in this embodiment, turn by applying a first speed to a first set of two wheels, e.g. the left set of wheels 1354, 1356 and a second speed to a second set of two wheels, e.g. the right set of wheels 1355, 1357. The first and second speeds may be different in order to turn the welding carriage.

FIG. 13 d) shows an articulated welding carriage control with centre chassis and independent axles. This embodiment is an alternative embodiment to FIG. 13 c) which comprises a sensor system 1360 for measuring the relative turning of the front and/or rear axles turn relative to the main centre part. A motor control system for the wheels may use the sensor system signals to turn the welding carriage. Compared to the embodiment of FIG. 13 c), this embodiment may enable a more advanced turning of the welding carriage.

FIG. 13 e) shows an articulated welding carriage control with individual motorized wheel turning. This embodiment comprises a common chassis (901) on which the wheels (902) are mounted through an individual wheel turning motor (1370). The wheels (902) may, for example, be mounted in each corner of the chassis (901) as illustrated in the figure. The welding carriage may, in this embodiment, turn by controlling a driving motor and a turning motor (1370) of each wheel. In one embodiment, the driving motor may be integrated in the turning motor.

In general, any of the technical features and/or embodiments described above and/or below may be combined into one embodiment. Alternatively or additionally any of the technical features and/or embodiments described above and/or below may be in separate embodiments. Alternatively or additionally any of the technical features and/or embodiments described above and/or below may be combined with any number of other technical features and/or embodiments described above and/or below to yield any number of embodiments.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A welding carriage (10) comprising a number of wheels (20, 30), where each wheel is pivotal around an axle (15) and where each wheel is a magnetic wheel; the welding carriage further comprises means (40) for supporting a welding device
characterized in that
at least one of the wheels (20, 30) of the welding carriage (10) is arranged to be flexed to assume more than one angle compared to a bottom side (12b) and/or top side (12a) of the welding carriage (10).

2. A welding carriage (10) according to claim 1, wherein said more than one angle comprises angles between −45° and 45° and more preferably between −30° and 30°.

3. A welding carriage (10) according to claim 1 further comprising a sensor arrangement (60) arranged to detect the position and the direction of a joint (95) to be welded.

4. A welding carriage (10) according to claim 3, wherein the sensor arrangement (60) is a laser sensor arrangement (60) arranged to emit at least two laser beams and to detect reflections of said at least two laser beams from a work piece (90).

5. A welding carriage (10) according to claim 1, further comprising means for tactilely detecting the position of a rail placed along a joint (95) to be welded.

6. A welding carriage (10) according to claim 3, further comprising a welding device and processor means (50) wherein the processor means (50) are arranged for controlling welding parameters of said welding device on basis of joint geometry measurements using said laser sensor arrangement.

7. A welding carriage (10) according to claim 6, wherein the controlling of welding parameters is based on a mathematical model, said mathematical model being either empirical, based on general laws of physics or a combination thereof.

8. A method (100) for operating a welding carriage (10) comprising a number of wheels (20, 30), where each wheel (20, 30) is pivotal around an axle (15) and where each wheel is a magnetic wheel; the welding carriage further comprises means (40) for supporting a welding device;
characterized in that
the method comprises the step of flexing at least one of the wheels to assume an angle (v) compared to a bottom and/or top side of the welding carriage.

9. A method (100) according to claim 8, wherein said angle (v) is an angle in the range between −45° and 45°, preferably between −30° and 30° and more preferably between 0° and 30°.

10. A method (100) according to claim 8, further comprising the steps of emitting at least two laser beams from a laser sensor arrangement (60) on the welding carriage (10) and detecting reflections of said at least two laser beams from a work piece (90) by means of said laser sensor arrangement.

11. A method (100) according to claim 8, further comprising a step of tactilely detecting the position of a rail placed along a joint to be welded.

12. A method (100) according to claim 10, further comprising emitting a laser beam and detecting reflections of said laser beam from a work piece by means of a laser sensor arrangement.

13. A method (100) according to claim 10, further comprising the step of controlling welding parameters of a welding device (70) supported by the welding carriage (10) on basis of detections of said reflections from a work piece (90) performed by means of said laser sensor arrangement (60), where the step of controlling the welding parameters is performed by means of processor means (50).

14. A method (100) according to claim 13, wherein the step of controlling of welding parameters is based on a mathematical model, said mathematical model being either empirical, based on general laws of physics or a combination thereof.
